(19) United States
(12) Patent Application Publication
(10) Pub. No.: US 2022/0318881 A1
(43) Pub. Date: Oct. 6, 2022

(54) ELECTRONIC APPARATUS AND INFORMATION PROVIDING METHOD THEREOF

(71) Applicant: Coupang Corp., Seoul (KR)

(72) Inventors: Jin Hee Kim, Seoul (KR); Ah Reum Hoang, Seoul (KR); Yeon Joo Ro, Seoul (KR); Jong Wook Lee, Seoul (KR); Yingying Chen, Seoul (KR)

(21) Appl. No.: 17/318,919

(22) Filed: May 12, 2021

(30) Foreign Application Priority Data
Mar. 31, 2021 (KR) 10-2021-0042312

(51) Int. Cl. G06Q 30/06; G06Q 30/02

(52) U.S. Cl. CPC G06Q 30/0629; G06Q 30/0257; G06Q 30/0271; G06Q 30/0643

(57) ABSTRACT

Disclosed is an information providing method of an electronic apparatus. The information providing method may include identifying a category selected by a user from among a plurality of categories, identifying a brand selected as a brand of interest by the user from among one or more brands in the category, and displaying products satisfying a certain condition among a plurality of products corresponding to the brand of interest in a partial area of a screen.

### BACKGROUND

### Technical Field

The present disclosure relates to an electronic apparatus for providing information related to a product satisfying a certain condition among a plurality of products corresponding to a brand of interest in a category selected by a user and an information providing method of the electronic apparatus.

### Description of the Related Art

When a buyer tries to purchase a product using an application, the buyer may select a category, and a product list corresponding to the category may be displayed on a screen. Here, providing information related to products that the user is likely to purchase among the plurality of products included in the category is a significant factor in improving sales in online commerce, and thus providing relevant information for the buyer's convenience of use may be a competitive advantage in online commerce. In the case of fashion products, a brand is a significant purchase factor in determining whether to purchase a product. Accordingly, there is a necessity for a technology for effectively providing information on or regarding products related to a brand in a category so as to induce a buyer to make a purchase.

### SUMMARY

### Technical Goals

An aspect of the present disclosure is directed to providing an electronic apparatus and an information providing method of the electronic apparatus. Goals of the present disclosure are not limited to those described above, and other goals may be inferred from the following example embodiments.

### Technical Solutions

According to an aspect, an information providing method of an electronic apparatus includes identifying a category selected by a user from among a plurality of categories, identifying a brand selected as a brand of interest by the user from among one or more brands in the category, and displaying products satisfying a certain condition among a plurality of products corresponding to the brand of interest in a partial area of a screen.

The certain condition may correspond to products which are within a certain period from registration dates thereof among the plurality of products corresponding to the brand of interest.

The displaying of the products satisfying the certain condition in the partial area of the screen may include, when the plurality of products are within the certain period from the registration dates thereof, displaying the products in the partial area of the screen in order of priority determined on the basis of, or based on, a comparison between a current time and the registration dates.

The identifying of the brand selected as the brand of interest by the user may include identifying the plurality of brands selected as the brand of interest by the user from among the one or more brands, and the displaying of the products in the partial area of the screen may include displaying the plurality of products corresponding to a plurality of brands on the basis of an order of priority.

The order of priority may be determined on the basis of at least one of sales volume information and registration date information of the plurality of products corresponding to the plurality of brands.

The displaying of the products in the partial area of the screen may include displaying the products together with images each corresponding to the products.

The displaying products satisfying the certain condition in the partial area of the screen may include displaying the products satisfying the certain condition among the plurality of products corresponding to the brand of interest related to the category selected by the user.

According to another aspect, an information providing method of an electronic apparatus includes identifying a category selected by a user from among a plurality of categories, identifying a product of interest selected by the user from among a plurality of products in the category, identifying a brand corresponding to the product of interest, and displaying products satisfying a certain condition among a plurality of products corresponding to the brand in a partial area of a screen.

The certain condition may correspond to the products which are within a certain period from registration dates thereof among the plurality of products corresponding to the brand.

The displaying of the products satisfying the certain condition in the partial area of the screen may include, when the plurality of products are within the certain period from the registration dates thereof, displaying the products in the partial area of the screen in order of priority determined on the basis of a comparison between a current time and the registration dates.

The identifying of the brand may include identifying, when the plurality of products are selected by the user as the product of interest from among the plurality of products in the category, the brands each corresponding to the plurality of products of interest, and the displaying of the products in the partial area of the screen may include displaying a plurality of products corresponding to the plurality of brands on the basis of an order of priority.

The order of priority may be determined on the basis of at least one of sales volume information and registration date information of the plurality of products corresponding to the plurality of brands.

The identifying of the brand corresponding to the product of interest may include identifying a product of interest selected by another user who corresponds to at least one of gender information and age information of the user, and identifying the brand corresponding to the product of interest selected by the user and a brand corresponding to the product of interest selected by the other user.

According to still another aspect of the present disclosure, an electronic apparatus includes a communication device, a display, and a controller configured to identify a category selected by a user from among a plurality of categories, identify a brand selected as a brand of interest by the user from among one or more brands in the category, and provide relevant information so that products satisfying a certain condition among a plurality of products corresponding to the brand of interest may be displayed in a partial area of the display.

According to yet another aspect of the present disclosure, a non-transitory computer-readable recording medium on which a program for executing the above-described method in a computer is recorded is provided.

Details of other aspects are included in the Detailed Description and the accompanying drawings.

### Effects

According to the present disclosure, the electronic apparatus can effectively provide information related to products included in a brand of interest selected by a user. Here, products satisfying a certain condition for the brand of interest in a category selected by the user are recommended such that the purchase rate of a user with high brand loyalty can be increased. Alternatively, the electronic apparatus can identify a brand corresponding to a product of interest selected by a user and effectively provide information related to products included in the brand. Also, a product of interest selected by another user whose gender and age are identical or similar to those of the user can be recommended such that the user's purchase rate can be increased. In other words, a user can easily check information related to products satisfying a certain condition for a brand through a user terminal such that the purchase rate of products included in a category and the brand can be increased. Here, since the display order of products is determined on the basis of at least one of sales volume information and registration date information, the user's purchase rate can be further increased.

Effects of the present disclosure are not limited to those described above, and other effects which have not been described will be clearly understood by those of ordinary skill in the art from the claims.

### BRIEF DESCRIPTION OF THE DRAWINGS

FIG. 1 illustrates a system according to an example embodiment.

FIG. 2 is a flowchart illustrating an information providing method performed in an electronic apparatus according to an example embodiment.

FIG. 3 is a flowchart illustrating an information providing method performed in an electronic apparatus according to an example embodiment.

FIG. 4 shows a screen displayed on a buyer terminal according to an example embodiment.

FIG. 5 shows a screen displayed on the basis of an input of a user according to an example embodiment.

FIG. 6 illustrates an operating method of an electronic apparatus according to an example embodiment.

FIG. 7 illustrates an operating method of an electronic apparatus according to another example embodiment.

FIG. 8 is a block diagram of an electronic apparatus according to an example embodiment.

### DETAILED DESCRIPTION

As terms used in example embodiments, general terms that are widely used at present are selected, when possible, in consideration of functions in the present disclosure, but the terms may vary according to intentions of those of ordinary skill in the art, precedents, the advent of new technologies, and the like. Some terms may be arbitrarily chosen by the present applicant, and in this case, the meanings of these terms will be described in the corresponding parts of description in detail. Accordingly, the terms used herein should be defined not on the basis of the names thereof but on the basis of the meanings thereof and the whole context of the present disclosure.

Throughout the specification, it will be understood that when a part is referred to as “including” an element, the part does not preclude other elements and may further include other elements unless particularly otherwise stated. Also, terms including “unit,” “module,” etc. used herein refer to units which perform at least one function or operation, and the unit, module, etc. may be implemented as hardware, software, or a combination of hardware and software.

Throughout the specification, the expression “at least one of a, b, and c” indicates only a, only b, only c, both a and b, both a and c, both b and c, and all of a, b, and c.

As used herein, a “terminal” may be implemented as a computer or a portable terminal which may access a server or another terminal via a network. Here, the computer includes, for example, a notebook computer, a desktop computer, a laptop computer, etc. on which a web browser is installed, and the portable terminal is a wireless communication device with portability and mobility and may include all kinds of handheld wireless communication devices such as communication-based terminals, smart phones, and tablet personal computers (PCs) which support international mobile telecommunication (IMT), code division multiple access (CDMA), wideband CDMA (W-CDMA), long term evolution (LTE), and the like.

Hereinafter, example embodiments of the present disclosure will be described in detail with reference to the accompanying drawings so that those of ordinary skill in the art may easily implement the present disclosure. However, the present disclosure may be implemented in various different forms and is not limited to the example embodiments set forth herein.

The example embodiments of the present disclosure will be described in detail below with reference to the drawings.

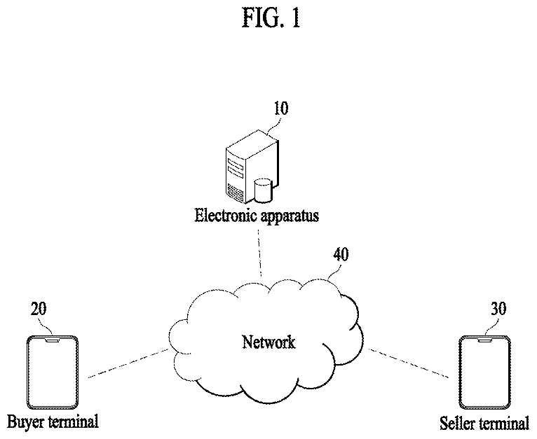

FIG. 1 illustrates a system according to an example embodiment.

Referring to FIG. 1, the system may include an electronic apparatus 10, a buyer terminal 20, a seller terminal 30, and a network 40. In the system shown in FIG. 1, only elements related to the present embodiment are shown. Accordingly, those of ordinary skill in the art may understand that general-use elements other than those shown in FIG. 1 may be further included.

The electronic apparatus 10, the buyer terminal 20, and the seller terminal 30 may communicate with each other through the network 40. The network 40 includes a local area network (LAN), a wide area network (WAN), a value added network (VAN), a mobile radio communication network, a satellite communication network, and combinations thereof. The network 40 is a data communication network having a comprehensive meaning that the network elements shown in FIG. 1 are allowed to smoothly communicate with each other and may include wired Internet, wireless Internet, and a mobile wireless communication network. Wireless communication may be, for example, wireless LAN (WLAN) (e.g., wireless fidelity (Wi-Fi)), Bluetooth, Bluetooth low energy, ZigBee, Wi-Fi direct (WFD), ultra-wideband (UWB), infrared data association (IrDA), near field communication (NFC), etc. but is not limited thereto.

The electronic apparatus 10 may provide all pieces of information related to products during a process of selling the products to buyers and may be included in a server which provides the information related to the products. Specifically, the electronic apparatus 10 may identify product information input by a seller through the seller terminal 30. Also, the electronic apparatus 10 may identify a category selected by the buyer through the buyer terminal 20. The electronic apparatus 10 may identify a product of interest selected by a user from among a plurality of products in the selected category, identify a brand corresponding to the product of interest, and display a list of products satisfying a certain condition among a plurality of products corresponding to the brand in a partial area of a screen. Alternatively, the electronic apparatus 10 may identify a category selected by the buyer through the buyer terminal 20, identify a brand selected by the user as a brand of interest from among one or more brands in the category, and display a list of products satisfying a certain condition among a plurality of products corresponding to the brand of interest in a partial area of the screen. The electronic apparatus 10 may provide information related to the item list using an application installed on the buyer terminal 20.

The electronic apparatus 10 may provide the application for providing information to the buyer terminal 20 and the seller terminal 30. The buyer terminal 20 may be a terminal used by the buyer, and the seller terminal 30 may be a terminal used by the seller. The seller may transmit product-related information to the electronic apparatus 10 through the seller terminal 30, and the buyer may check a product list corresponding to a search term using the information provided by the electronic apparatus 10 and make a purchase through the buyer terminal 20. The buyer may purchase a product on the basis of the information uploaded to the electronic apparatus 10 by the seller.

A detailed process performed by the electronic apparatus 10, the buyer terminal 20, and the seller terminal 30 with regard to information providing will be described below.

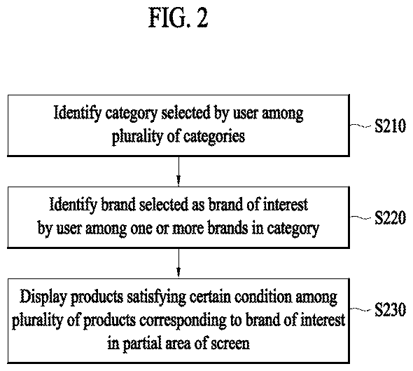

FIG. 2 is a flowchart illustrating an information providing method performed in an electronic apparatus according to an example embodiment.

Referring to FIG. 2, in operation S210, an electronic apparatus may identify a category selected by a user from among a plurality of categories. The electronic apparatus may classify products into the plurality of categories in advance, and the user may select the previously classified category and check information related to the products corresponding to the category. For example, the electronic apparatus may classify fashion products into categories such as a female category, a male category, and a kid category. When the user selects the female category, information related to the female fashion products corresponding to the female category may be provided to the user. Here, categories are distinguished based on information input by a seller with regard to the product. For example, when the seller inputs the female category as information related to Product 1 corresponding to Brand 1, the electronic apparatus may recognize Product 1 as a product corresponding to the female category. Alternatively, when the seller inputs the male category as information related to Product 2 corresponding to Brand 1 which is the same as above, the electronic apparatus may recognize Product 2 as a product corresponding to the male category.

In operation S220, the electronic apparatus may identify a brand selected as a brand of interest by the user from among one or more brands in the category. Specifically, Brand 1 to Brand N may be included in the female category, and the user may select a brand of interest. For example, when the user selects the female category, the electronic apparatus may identify Brand 1 to Brand 3 selected by the user as brands of interest from among the plurality of brands included in the female category.

In operation S230, the electronic apparatus may display products satisfying a certain condition among a plurality of products corresponding to the brand of interest in a partial area of a screen. Specifically, the electronic apparatus may display products corresponding to the certain condition among a plurality of products corresponding to Brand of interest 1, products corresponding to the certain condition among a plurality of products corresponding to Brand of interest 2, and products corresponding to the certain condition among a plurality of products corresponding to Brand of interest 3 in the partial area of the screen. More specifically, the electronic apparatus may display products which are within a certain period from registration dates thereof among the plurality of products corresponding to the brand of interest. The seller may input information related to the products, and the electronic apparatus may identify registration date information on the basis of the information input by the seller. While launching the products, the seller may input the information related to the products into the electronic apparatus, and in this case, information on a date on which the products are registered and information on a date on which the products are launched may be the same. Alternatively, the seller may launch the products and then input the information related to the products into the electronic apparatus, and in this case, information on a date on which the products are registered and information on a date on which the products are launched may differ from each other. The electronic apparatus may identify at least one product satisfying the certain condition using the registration date information input by the seller.

According to the example embodiment, when a plurality of products are within the certain period from registration dates thereof, the electronic apparatus may identify products in order of priority determined on the basis of a comparison between a current time and the registration dates. Specifically, when a plurality of products are within the certain period from registration dates thereof among the plurality of products corresponding to the brand of interest, the electronic apparatus may display the plurality of products in the partial area of the screen in reverse chronological order of registration date.

According to the example embodiment, when the user selects a plurality of brands of interest, the electronic apparatus may display a plurality of products corresponding to the plurality of brands of interest in order of priority. Here, the electronic apparatus may display the plurality of products corresponding to the plurality of brands in order of priority determined on the basis of at least one of sales volume information and registration date information. For example, the electronic apparatus may display a plurality of products corresponding to Brand of interest 1 to Brand of interest 3 in decreasing order of sales volume. Specifically, the electronic apparatus may display the products in order of sales volume such as Product 1 corresponding to Brand of interest 1, Product 1 corresponding to Brand of interest 3, Product 2 corresponding to Brand of interest 1, and Product 1 corresponding to Brand of interest 2. Alternatively, the electronic apparatus may display a plurality of products corresponding to Brand of interest 1 to Brand of interest 3 in reverse chronological order of registration date. Specifically, the electronic apparatus may display the products in reverse chronological order of registration date such as Product 1 corresponding to Brand of interest 3, Product 2 corresponding to Brand of interest 1, Product 1 corresponding to Brand of interest 1, and Product 3 corresponding to Brand of interest 2.

Here, the sales volume information may include at least one of the cumulative sales volume of the product and an increase rate of sales of the product during a preset period. For example, the sales volume information may include the cumulative sales volume of the product and an increase rate of sales of the product during the last two weeks. The product satisfying the certain condition for being displayed in the partial area of the screen may be a fashion-sensitive product. Due to characteristics of a fashion-sensitive product, the cumulative sales volume may be low, but the increase rate of sales may be high during a certain period. Here, different weights may be applied to the sales volume and the increase rate of sales. The weights may be determined on the basis of, or based on, the user's purchase history information, and the display order of products may be determined according to the weights determined on the basis of the purchase history information. Specifically, the electronic apparatus may analyze the user's purchase history information to determine whether the user tends to purchase a product with a high cumulative sales volume or a product with a high increase rate of sales during the certain period. Here, the weights may be determined on the basis of the ratio between the number of times a product with a high cumulative sales volume is purchased and the number of times a product with a high increase rate of sales is purchased, and the order of priority may be determined in consideration of the weights. For example, as a result of analyzing ten products purchased by the user in the past among products displayed in the partial area of the screen, the user may have purchased products with a high cumulative sales volume seven times and have purchased products with a high increase rate of sales during the certain period three times. In this case, the electronic apparatus may apply weights of 7:3 to the sales volume and the increase rate of sales and determine the ratio and order of products displayed in the partial area of the screen on the basis of the order of priority based on the weights.

According to the example embodiment, when a product satisfies the certain condition among the plurality of products corresponding to the brand of interest, the electronic apparatus may display the product in the partial area of the screen. On the other hand, when no product satisfies the certain condition, the electronic apparatus may not display product information in the partial area of the screen. Accordingly, the user can easily check a latest product or a product with high sales volume in the brand of interest using an interface.

According to the example embodiment, when the user does not respond to or select a product displayed in the partial area of the screen a preset number of times or more, the product may be filtered out. When a customer does not click a product displayed in the partial area of the screen the preset number of times or more, the customer is determined to be uninterested in the product, and the purchase rate may be reduced. For example, when the user does not click a product displayed in the partial area of the screen the preset number of times (ten times), the product may be filtered out and may not be displayed.

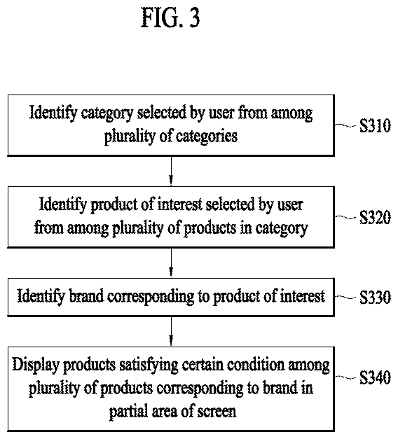

FIG. 3 is a flowchart illustrating an information providing method performed in an electronic apparatus according to an example embodiment.

Referring to FIG. 3, in operation S310, an electronic apparatus may identify a category selected by a user from among a plurality of categories. The electronic apparatus may classify products into the plurality of categories in advance, and the user may select the previously classified category and check information related to the products corresponding to the category. For example, the electronic apparatus may classify fashion products into categories such as a female category, a male category, and a kid category. When the user selects the female category, information related to the female fashion products corresponding to the female category may be provided to the user. Here, categories are distinguished based on information input by a seller with regard to the product. For example, when the seller inputs the female category as information related to Product 1 corresponding to Brand 1, the electronic apparatus may recognize Product 1 as a product corresponding to the female category. Alternatively, when the seller inputs the male category as information related to Product 2 corresponding to Brand 1 which is the same as above, the electronic apparatus may recognize Product 2 as a product corresponding to the male category.

In operation S320, the electronic apparatus may identify a product of interest selected by the user from among a plurality of products in the category. Specifically, the user may select a product of interest from among a plurality of products included in the female category. For example, when the user selects the female category, the electronic apparatus may identify Product 1 to Product 3 selected by the user as products of interest from among the plurality of products included in the female category.

In operation S330, the electronic apparatus may identify a brand corresponding to the product of interest. The electronic apparatus may identify a brand corresponding to the product which is selected as the product of interest by the user. For example, the electronic apparatus may identify Brand 1 corresponding to Product of interest 1 selected by the user, Brand 2 corresponding to Product of interest 2 selected by the user, and Brand 3 corresponding to Product of interest 3 selected by the user.

Also, the electronic apparatus may identify a product of interest selected by another user who corresponds to at least one of gender information and age information of the user. For example, the electronic apparatus may identify a product of interest selected by User B who corresponds to at least one of a gender and an age of User A who is a female in her twenties. Accordingly, the electronic apparatus identifies not only a product of interest selected by a user but also a product of interest selected by other users who have common characteristics and provides relevant information such that the user's purchase rate can be increased.

In operation S340, the electronic apparatus may display products satisfying a certain condition among a plurality of products corresponding to the brand in a partial area of a screen.

Specifically, the electronic apparatus may display products satisfying the certain condition among the plurality of products corresponding to the brand identified in operation S330 in the partial area of the screen. For example, the electronic apparatus may display products corresponding to the certain condition among a plurality of products corresponding to Brand 1, products corresponding to the certain condition among a plurality of products corresponding to Brand 2, and products corresponding to the certain condition among a plurality of products corresponding to Brand 3 in the partial area of the screen. More specifically, the electronic apparatus may display products which are within a certain period from registration dates thereof among the plurality of products corresponding to the brand identified in operation S330 in the partial area of the screen. The seller may input information related to the products, and the electronic apparatus may identify registration date information on the basis of the information input by the seller. While launching the products, the seller may input the information related to the products into the electronic apparatus, and in this case, information on a date on which the products are registered and information on a date on which the products are launched may be the same. Alternatively, the seller may launch the products and then input the information related to the products into the electronic apparatus, and in this case, information on a date on which the products are registered and information on a date on which the products are launched may differ from each other. The electronic apparatus may identify at least one product satisfying the certain condition using the registration date information input by the seller. Also, the electronic apparatus may identify brands corresponding to a product of interest selected by the user and a product of interest selected by another user. For example, the electronic apparatus may identify a product of interest selected by User A and a product of interest selected by User B. Accordingly, the electronic apparatus can provide relevant information regarding products of not only a brand corresponding to the product of interest selected by User A but also a brand corresponding to the product of interest selected by User B.

According to the example embodiment, when a plurality of products are within the certain period from registration dates thereof, the electronic apparatus may identify the products in order of priority determined on the basis of a comparison between a current time and the registration dates. Specifically, when a plurality of products are within the certain period from registration dates thereof among a plurality of products included the brand corresponding to the product of interest, the electronic apparatus may display the plurality of products in the partial area of the screen in reverse chronological order of registration date.

According to the example embodiment, when a plurality of brands are identified in operation S330, the electronic apparatus may display a plurality of products corresponding to the plurality of brands in order of priority. Here, the electronic apparatus may display the plurality of products corresponding to the plurality of brands in order of priority determined on the basis of at least one of sales volume information and registration date information. For example, the electronic apparatus may display a plurality of products corresponding to Brand 1 to Brand 3 in decreasing order of sales volume. Specifically, the electronic apparatus may display the products in order of sales volume such as Product 1 corresponding to Brand 1, Product 1 corresponding to Brand 3, Product 2 corresponding to Brand 1, and Product 1 corresponding to Brand 2. Alternatively, the electronic apparatus may display a plurality of products corresponding to Brand 1 to Brand 3 in reverse chronological order of registration date. Specifically, the electronic apparatus may display the products in reverse chronological order of registration date such as Product 1 corresponding to Brand 3, Product 2 corresponding to Brand 1, Product 1 corresponding to Brand 1, and Product 3 corresponding to Brand 2.

Here, the sales volume information may include at least one of the cumulative sales volume of the product and an increase rate of sales of the product during a preset period. For example, the sales volume information may include the cumulative sales volume of the product and an increase rate of sales of the product during the last two weeks. The product satisfying the certain condition for being displayed in the partial area of the screen may be a fashion-sensitive product. Due to characteristics of a fashion-sensitive product, the cumulative sales volume may be low, but the increase rate of sales may be high during a certain period. Here, different weights may be applied to the sales volume and the increase rate of sales. The weights may be determined on the basis of the user's purchase history information, and the display order of products may be determined according to the weights determined on the basis of the purchase history information. Specifically, the electronic apparatus may analyze the user's purchase history information to determine whether the user tends to purchase a product with a high cumulative sales volume or a product with a high increase rate of sales during the certain period. Here, the weights may be determined on the basis of the ratio between the number of times a product with a high cumulative sales volume is purchased and the number of times a product with a high increase rate of sales is purchased, and the order of priority may be determined in consideration of the weights. For example, as a result of analyzing ten products purchased by the user in the past among products displayed in the partial area of the screen, the user may have purchased products with a high cumulative sales volume seven times and have purchased products with a high increase rate of sales during the certain period three times. In this case, the electronic apparatus may apply weights of 7:3 to the sales volume and the increase rate of sales and determine the ratio and order of products displayed in the partial area of the screen on the basis of the order of priority based on the weights.

According to the example embodiment, when a product satisfies the certain condition among the plurality of products corresponding to the brand, the electronic apparatus may display the product in the partial area of the screen. On the other hand, when no product satisfies the certain condition, the electronic apparatus may not display product information in the partial area of the screen. Accordingly, the user can easily check a latest product or a product with high sales volume in the brand using an interface.

According to the example embodiment, when the user does not respond to or select a product displayed in the partial area of the screen a preset number of times or more, the product may be filtered out. When a customer does not click a product displayed in the partial area of the screen the preset number of times or more, the customer is determined to be uninterested in the product, and the purchase rate may be reduced. For example, when the user does not click a product displayed in the partial area of the screen the preset number of times (ten times), the product may be filtered out and may not be displayed.

According to the example embodiment, when products of interest belong to the same brand among a plurality of products of interest selected by the user, the order of priority may be determined on the basis of the number of products of interest selected by the user. For example, when the user selects ten products of interest, five products of interest may correspond to Brand 1, two products of interest may correspond to Brand 2, and three products of interest may correspond to Brand 3. In this case, a ratio of products which may be displayed in the partial area of the screen may be determined in consideration of the number of products of interest for each brand. Specifically, when products which may be displayed in the partial area of the screen are limited to a preset number (e.g., twenty), ten products corresponding to Brand 1, four products corresponding to Brand 2, and six products corresponding to Brand 3 may be displayed in the partial area of the screen according to the preset number. Here, the ten products corresponding to Brand 1 may be determined from among a plurality of products included in Brand 1 in consideration of at least one of sales volume information and registration date information. The four products corresponding to Brand 2 may be determined from among a plurality of products included in Brand 2 in consideration of at least one of sales volume information and registration date information. The six products corresponding to Brand 3 may be determined from among a plurality of products included in Brand 3 in consideration of at least one of sales volume information and registration date information. With regard to the twenty products displayed in the partial area of the screen, the electronic apparatus may determine the display order according to the order of priority determined in consideration of at least one of sales volume information and registration date information. In other words, among twenty products which may be displayed in the partial area of the screen, products corresponding to Brand 1, Brand 2, and Brand 3 may be determined to be 50%, 20%, and 30%, respectively. Also, the display order of the products corresponding to Brand 1 to Brand 3 may be determined in consideration of at least one of sales volume information and registration date information.

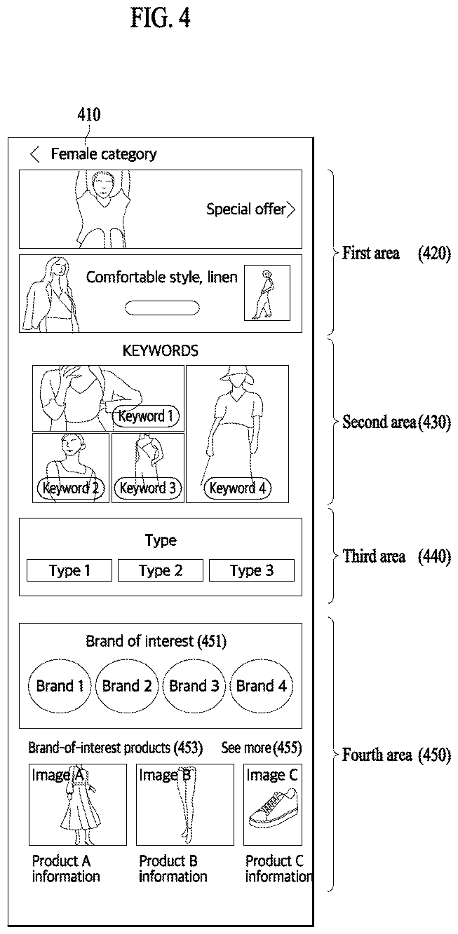

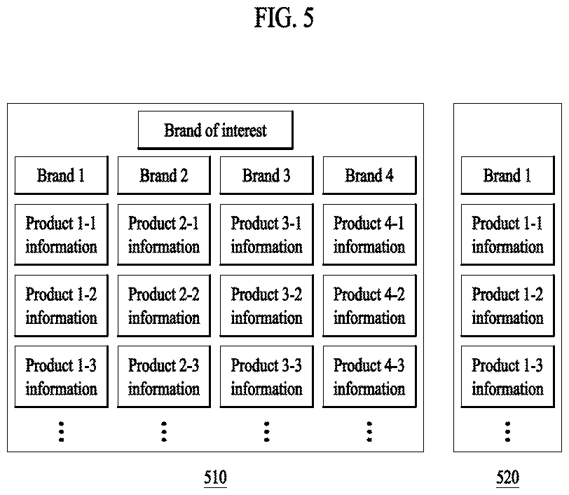

FIG. 4 shows a screen displayed on a buyer terminal according to an example embodiment. FIG. 5 shows a screen displayed on the basis of an input of a user according to an example embodiment.

Referring to FIG. 4, the electronic apparatus may display a screen corresponding to a category selected by the user among a plurality of categories. For example, when the user selects a female category 410, the electronic apparatus may display a screen corresponding to the female category 410 as shown in FIG. 4. Here, the displayed screen may show information related to the female category 410.

The screen may include a first area 420. In the first area 420, advertisement or marketing information may be displayed in connection with the female category 420.

The screen may include a second area 430. In the second area 430, main keywords related to the female category 410 may be displayed. Specifically, at least one keyword derived by analyzing a plurality of users' purchase history information in connection with the female category 410 may be displayed in the second area 430. For example, as a result of analyzing a plurality of users' purchase history information within the last month in connection with the female category 410, a search term which has been most searched or a keyword related a product which has been sold the most may be displayed in the second area 430. For example, Keyword 1, Keyword 2, Keyword 3, and Keyword 4 related to a search term which has been most searched during a certain period may be displayed in the second area 430.

The screen may include a third area 440. In the third area 440, information related to types corresponding to the female category 410 may be displayed. For example, information related to types, such as shirts, skirts, pants, and dresses, related to the female category 410 may be displayed in the third area 440. Specifically, Type 1, Type 2, and Type 3 related to the female category 410 may be displayed in the third area 440.

The screen may include a fourth area 450. In the fourth area 450, information related to a brand of interest 451 may be displayed. The brand of interest 451 may correspond to a brand selected by the user as illustrated in FIG. 2 or may be a brand corresponding to a product of interest selected by the user as illustrated in FIG. 3. As examples of the brand of interest 451, FIG. 4 shows Brand 1, Brand 2, Brand 3, and Brand 4.

Brand-of-interest products 453 may be products which are displayed in a partial area of the screen as products satisfying the certain condition among a plurality of products corresponding to the brand of interest. For example, Image A and Product A information may be displayed in connection with Product A, Image B and Product B information may be displayed in connection with Product B, and Image C and Product C information may be displayed in connection with Product C. Also, when a See more 455 is clicked, products corresponding to the brand-of-interest products 453 may be additionally identified. Product A may correspond to Brand 2, Product B may correspond to Brand 1, and Product C may correspond to Brand 4. The above descriptions may apply to products displayed as the brand-of-interest products 453.

According to the example embodiment, a page which shows a product list corresponding to each brand may be displayed as shown in a portion 520 of FIG. 5 on the basis of, or based on, the user's input for Brand 1 to Brand 4 included in the brand of interest 451. Specifically, when the user selects Brand 1 in the fourth area 450, the electronic apparatus may switch the screen to a page which shows products corresponding to the selected Brand 1 as shown in the portion 520. More specifically, when the user keeps a click on Brand 1, Brand 2, Brand 3, or Brand 4 for a certain period or more, the electronic apparatus may switch the screen to a page which shows products corresponding to each brand as shown in the portion 520. For example, when the user clicks on Brand 1 for three seconds, the electronic apparatus may display Product 1-1 information, Product 1-2 information, and Product 1-3 information satisfying the certain condition for Brand 1 in order of sales volume as shown in the portion 520. In other words, the screen is switched to a page, which shows products satisfying the certain condition with regard to only a brand selected by the user rather than other brands, by the user's click. Accordingly, the convenience of the user who wants to purchase the corresponding product can be improved, and the purchase rate can be increased. Alternatively, when a mouse pointer is located on Brand 1, the electronic apparatus may additionally display images of some top products with high sales volume in a list of products included in the corresponding brand without screen transition. For example, when the mouse pointer is located on Brand 1, the electronic apparatus may additionally display Product 1-1 information, Product 1-2 information, and Product 1-3 information with high sales volume in a list of products included in Brand 1 on the current screen without screen transition. Accordingly, since the user can check products with high sales volume in the corresponding brand on the current screen without screen transition, convenience in comparison between products can be improved, and the purchase rate can be increased.

According to the example embodiment, a page which shows a product list corresponding to brands may be displayed as shown in a portion 510 of FIG. 5 on the basis of the user's input for the brand of interest 451. Specifically, when the user clicks on the brand of interest 451 in the fourth area 450 for the certain period or more, the electronic apparatus may switch the screen to a page which shows products corresponding to brands as shown in the portion 510. Accordingly, it is possible to easily check top products with high sales volume according to each brand, and thus user convenience can be improved.

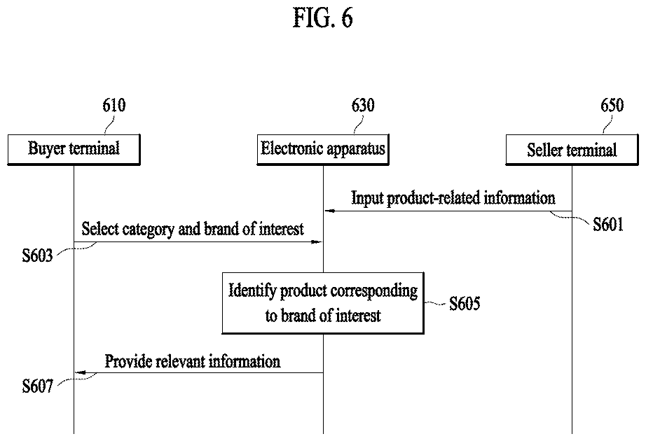

FIG. 6 illustrates an operating method of an electronic apparatus according to an example embodiment.

Referring to FIG. 6, in operation S601, a seller terminal 650 may input and transmit information related to a product to an electronic apparatus 630. Specifically, when a seller registers a product for sale using an application installed on the seller terminal 650, the seller may input information related to the product, and the electronic apparatus 630 may identify the information related to the product through the application. Here, the information related to the product may include registration information of the product and date information related to launching of the product. The registration information of the product may include information related to registration of the product, and the date information related to launching may include information related to the date on which the product is released to the market.

In operation S603, a buyer may select a category and a brand of interest using a buyer terminal 610. Specifically, the buyer may select one of a plurality of categories and select a brand of interest from among one or more brands in the category. For example, the buyer may select a female category among a male category, a female category, and a kid category and select a brand of interest from among one or more brands included in the female category.

In operation S605, the electronic apparatus may identify products corresponding to the brand of interest. Specifically, the electronic apparatus may identify a product satisfying a certain condition from among a plurality of products corresponding to the brand of interest.

In operation S607, the electronic apparatus may provide relevant information to the buyer terminal 610. Specifically, the electronic apparatus may provide information related to the product satisfying the certain condition through the application. FIGS. 4 and 5 may exemplify a screen displayed in the buyer terminal 610.

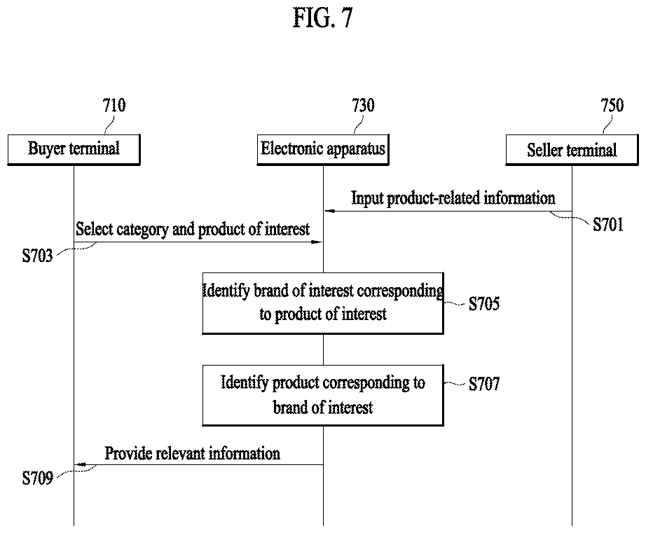

FIG. 7 illustrates an operating method of an electronic apparatus according to another example embodiment.

Referring to FIG. 7, in operation S701, a seller terminal 750 may input and transmit information related to a product to an electronic apparatus 730. Specifically, when a seller registers a product for sale using an application installed on the seller terminal 750, the seller may input information related to the product, and the electronic apparatus 730 may identify the information related to the product through the application. Here, the information related to the product may include registration information of the product and date information related to launching of the product. The registration information of the product may include information related to registration of the product, and the date information related to launching may include information related to the date on which the product has come into the market.

In operation S703, a buyer may select a category and a product of interest using a buyer terminal 710. Specifically, the buyer may select one of a plurality of categories and select a product of interest from among a plurality of products in the category. For example, the buyer may select a female category from among a male category, a female category, and a kid category and select a product of interest from among a plurality of products included in the female category.

In operation S705, the electronic apparatus may identify a brand of interest corresponding to the product of interest. For example, when a user selects Product of interest 1, Product of interest 2, and Product of interest 3, the electronic apparatus may identify Brand of interest 1 corresponding to Product of interest 1, Brand of interest 2 corresponding to Product of interest 2, and Brand of interest 3 corresponding to Product of interest 3.

In operation S707, the electronic apparatus may identify a product corresponding to the brand of interest. Specifically, the electronic apparatus may identify a product satisfying a certain condition from among a plurality of products corresponding to the brand of interest identified in operation S705.

In operation S709, the electronic apparatus may provide relevant information to the buyer terminal 710. Specifically, the electronic apparatus may provide information related to the product satisfying the certain condition through the application. FIGS. 4 and 5 may exemplify a screen displayed in the buyer terminal 710.

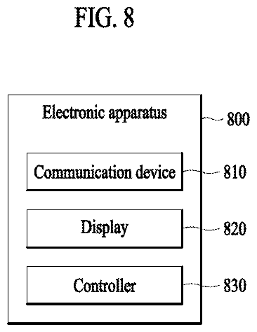

FIG. 8 is a block diagram of an electronic apparatus according to an example embodiment.

An electronic apparatus 800 may include a communication device 810, a display 820, and a controller 830 according to the example embodiment. In the electronic apparatus 800 shown in FIG. 8, only elements related to the present embodiment are shown. Accordingly, those of ordinary skill in the art may understand that general-use elements other than those shown in FIG. 8 may be further included. Since the above description of the electronic apparatus may apply to the electronic apparatus 800, a description of overlapping content is omitted.

The communication device 810 is a device for performing wired or wireless communication and may communicate with an external apparatus. The external apparatus may be a terminal or a server. Communication technology employed by the communication device 810 may be global system for mobile communication (GSM), CDMA, LTE, fifth generation (5G), WLAN, Wi-Fi, Bluetooth™, radio frequency identification (RFID), IrDA, ZigBee, NFC, and the like. According to the example embodiment, the communication device 810 may be referred to as a transceiver, and the electronic apparatus 800 may exchange information with the terminal through the transceiver.

The display 820 may display information related to the operation of the electronic apparatus 800. Alternatively, the display 820 may display information related to a screen displayed through an application.

The controller 830 may control the overall operation of the electronic apparatus 800 and process data and signals. The controller 830 may be configured with at least one hardware unit. Also, the controller 830 may be operated by one or more software modules which are generated by executing program code stored in a memory. The controller 830 may include a processor and the memory, and the processor may control the overall operation of the electronic apparatus 800 and process data and signals by executing program code stored in the memory. According to the example embodiment, the controller 830 may include at least one processor.

The controller 830 may identify a brand corresponding to a product of interest in a category selected by a user and display a product satisfying a certain condition among a plurality of products corresponding to the brand in a partial area of a screen. Alternatively, the controller 830 may identify a brand of interest in a category selected by a user and display a product satisfying a certain condition among a plurality of products corresponding to the brand of interest in a partial area of the screen.

An electronic apparatus or a terminal according to the above-described embodiments may include a processor, a memory in which program data is stored and executed, a permanent storage such as a disk drive, a communication port which communicates with an external device, a user interface such as a touch panel, keys, and buttons, and the like. Methods implemented as software modules or algorithms may be stored as computer-readable code or program commands, which can be executed by the processor, in a computer-readable recording medium. Examples of the computer-readable recording medium include magnetic storage media (e.g., a read-only memory (ROM), a random-access memory (RAM), a floppy disk, and a hard disk), optical reading media (e.g., a compact disc (CD)-ROM and a digital versatile disc (DVD)), and the like. The computer-readable recording medium can also be distributed over computer systems connected via a network such that the computer-readable code can be stored and executed in a distributed manner. The computer-readable recording medium can be read by a computer, stored in the memory, and executed by the processor.

The example embodiments of the present disclosure may be represented as functional blocks and various processing operations. The functional blocks may be implemented as a plurality of hardware and/or software elements which execute specific functions. For example, the embodiments may employ integrated circuit elements including a memory, processing, a logic, a look-up table, etc. which may execute various functions through control of one or more microprocessors or other control devices. While elements of the embodiments may be executed by software programming or software elements, the embodiments may be implemented with programming or scripting languages including C, C++, Java, assembler, etc. to include various algorithms which are implemented as combinations of data structures, processes, routines, or other programming elements. Functional aspects may be implemented using algorithms which are executed by one or more processors. Also, the embodiments may employ conventional techniques for electronic environment setting, signal processing, data processing, and/or the like. The terms such as “mechanism,” “element,” “means,” and “structure” may be widely used and are not limited to mechanical and physical configurations. The terms may include the meanings of a series of routines of software in connection with a processor and the like.

The above-described embodiments are only exemplary, and other embodiments may be implemented in the scope of the following claims.

1. An information providing method of an electronic apparatus, the method comprising:
receiving data corresponding to sales of a product during a preset period;
calculating a sales volume value and a rate of sales value for the product during the preset period;
receiving a purchase history of a user;
calculating, from the purchase history of the user, a likelihood that the user will purchase the product as a result of a higher cumulative sales volume or a higher increase in rate of sales during the preset period;
generate an ordered product list, based upon the calculated likelihood and a calculated weight, wherein the weight is calculated as a ratio between a number of times a product with a high cumulative sales volume is purchased and a number of times a product with a high increase rate of sales is purchased;
identifying a category selected by a user from among a plurality of categories;
identifying a brand selected as a brand of interest by the user from among one or more brands in the category; and
displaying, in a partial area of a screen, products satisfying a certain condition among a plurality of products corresponding to the brand of interest, wherein the displaying is ordered based upon the ordered product list.

2. The information providing method of claim 1, wherein the certain condition corresponds to products which are within a certain period from registration dates thereof among the plurality of products corresponding to the brand of interest.

3. The information providing method of claim 2, wherein the displaying of the products satisfying the certain condition in the partial area of the screen comprises, when the plurality of products are within the certain period from the registration dates thereof, displaying the products in the partial area of the screen in an order of priority determined based on a comparison between a current time and the registration dates.

4. The information providing method of claim 1, wherein:
the identifying of the brand selected as the brand of interest by the user comprises identifying the plurality of brands selected as the brand of interest by the user from among the one or more brands, and
the displaying of the products in the partial area of the screen comprises displaying a plurality of products corresponding to the plurality of brands based on an order of priority.

5. The information providing method of claim 4, wherein the order of priority is determined based on at least one of sales volume information or registration date information of the plurality of products corresponding to the plurality of brands.

6. The information providing method of claim 4, wherein the displaying of the products in the partial area of the screen comprises displaying the products together with images each corresponding to the products.

7. The information providing method of claim 1, wherein the displaying products satisfying the certain condition in the partial area of the screen comprises displaying products satisfying a certain condition among a plurality of products corresponding to the brand of interest related to the category selected by the user.

8. An information providing method of an electronic apparatus, the method comprising:
receiving data corresponding to sales of a product during a preset period;
calculating a sales volume value and a rate of sales value for the product during the preset period;
receiving a purchase history of a user;
calculating, from the purchase history of the user, a likelihood that the user will purchase the product as a result of a higher cumulative sales volume or a higher increase in rate of sales during the preset period;
generate an ordered product list, based upon the calculated likelihood and a calculated weight wherein the weight is calculated as a ratio between a number of times a product with a high cumulative sales volume is purchased and a number of times a product with a high increase rate of sales is purchased;
identifying a category selected by a user from among a plurality of categories;
identifying a product of interest selected by the user from among a plurality of products in the category;
identifying a brand corresponding to the product of interest; and
displaying products satisfying a certain condition among a plurality of products corresponding to the brand in a partial area of a screen, wherein the displaying is ordered based upon the ordered product list.

9. The information providing method of claim 8, wherein the certain condition corresponds to products which are within a certain period from registration dates thereof among the plurality of products corresponding to the brand.

10. The information providing method of claim 9, wherein the displaying of the products satisfying the certain condition in the partial area of the screen comprises, when the plurality of products are within the certain period from the registration dates thereof, displaying the products in the partial area of the screen in order of priority determined based on a comparison between a current time and the registration dates.

11. The information providing method of claim 8, wherein:
the identifying of the brand comprises identifying, when the plurality of products are selected by the user as the product of interest from among the plurality of products in the category, brands each corresponding to the plurality of products of interest, and
the displaying of the products in the partial area of the screen comprises displaying a plurality of products corresponding to the plurality of brands based on an order of priority.

12. The information providing method of claim 11, wherein the order of priority is determined based on at least one of sales volume information or registration date information of the plurality of products corresponding to the plurality of brands.

13. The information providing method of claim 8, wherein the identifying of the brand corresponding to the product of interest comprises:
identifying a product of interest selected by another user who corresponds to at least one of gender information and age information of the user; and
identifying the brand corresponding to the product of interest selected by the user and a brand corresponding to the product of interest selected by the other user.

14. (canceled)

15. An electronic apparatus comprising:
a communication device;
a display; and
a controller configured to:
receive data corresponding to sales of a product during a preset period;
calculate a sales volume value and a rate of sales value for the product during the preset period;
receive a purchase history of a user;
calculate, from the purchase history of the user, a likelihood that the user will purchase the product as a result of a higher cumulative sales volume or a higher increase in rate of sales during the preset period;
generate an ordered product list, based upon the calculated likelihood and a calculated weight, wherein the weight is calculated as a ratio between a number of times a product with a high cumulative sales volume is purchased and a number of times a product with a high increase rate of sales is purchased;
identify a category selected by a user from among a plurality of categories;
identify a brand selected as a brand of interest by the user from among one or more brands in the category; and
provide relevant information so that products satisfying a certain condition among a plurality of products corresponding to the brand of interest are displayed in a partial area of the display, ordered based upon the ordered product list.
